(19) United States
(12) Patent Application Publication
(10) Pub. No.: US 2003/0168540 A1
(43) Pub. Date: Sep. 11, 2003

(54) Split guide device for double bearing fishing reel

(76) Inventor: Kenneth John Alme, Oakdale, MN (US)

Correspondence Address: Kenneth J. Alme, 8049 9th Street Way North, Oakdale, MN, 55128, US

(21) Appl. No.: 10/092,605

(22) Filed: Mar. 8, 2002

(51) Int. Cl. A01K 89/015

(52) U.S. Cl. 242/279

(57) ABSTRACT

A double bearing type reel includes: a reel main body having a pair of side plates; a spool rotatably supported between the side plates and a fishline guide device reciprocatingly provided between the side plates extending in front of the spool, said fishline guide device winding a fishline parallel around the spool. The fishline guide device is constructed to divide into two parts, effectively splitting with each half traveling to the adjacent edge of the side plate during the fishline play-out state and returning and attaching to form a single guide structure for the fishline take-up state.

### FIELD OF THE INVENTION

The present invention relates to a fishline guide device for a double bearing type fishing reel, which is structured such that it takes up a fishline parallel around a spool.

### BACKGROUND OF THE INVENTION

Conventionally, there is generally known a fishing reel including a fishine guide device which is used to wind a fishline parallel around a spool rotatably supported between the two side plates of a reel main body.

Each of the conventional fishline guide devices includes a fishline guide portion, while the fishline guide portion is normally formed in a round shape or in an elliptical shape being narrow in width because it must have a function to wind a fishline parallel around a spool being large in width.

As shown in FIG. 5., a fishline “a”, which is played out from a spool in a fishline play-out operation, is played out forwardly while spreading out upwardly like a “b” manner, that is, more widely than the winding diameter of the fishline around the spool due to the relationship between a velocity at which the terminal tackles (such as a sinker, a lure and the like) of the fishing reel pull the fishline and a centrifugal force which is applied to the fishline when the spool is rotated.

Also, as shown in FIG. 5., since the fishline is caused to spread out right and left by an amount equivalent to the width of the spool “c” according to a diagonal angle formed due to a width difference between the fishline guide portion “d” of a fishline guide device and the spool, there is a possibility that there can be produced a difference between the play-out position of the fishline wound around the spool and the fishline guide portion. Also, during the line play-out operation, the differences in the rotational speed of the spool and the line being drawn by the terminal tackle are compounded by the diagonal angle, resulting in a jerking of the line as it is unwound from the spool. This contributes to a backlash phenomenon, in which the fishline becomes loosened because the speed of rotation of the spool becomes higher than the speed of release of the fishline.

On the other hand, if the whole transverse width of the fishline guide portion is increased, then the winding condition of the fishline is worsened.

As described above, in an actual fishing operation, in more particular, in the fishline play-out operation thereof, due to the influences as shown in FIGS. 5., the fishline is contacted with the fishline guide portion to thereby receive resistance therefrom. This lowers the casting distance of the terminal tackle.

### DESCRIPTION OF THE RELATED ART

Conventionally, as disclosed in U.S. Pat. No. 6,053,444, Yamaguchi addresses the backlash phenomena as described above by including in the fishing reel a fishline guide device which operates in a conventional manner, moving in a reciprocating manner in the fishline takeup operation.

During the fishline play-out operation, however, Yamaguchi's fishline guide device rotates forward, playing the line out through a v-shaped guide, which allows the fishline to be drawn at a more consistent rate a greater width of the spool.

While Yamaguchi's design addresses the differences between the velocity of the terminal tackle and the rotational speed of the spool, resulting in fishline slack and ultimately, backlash, it results in a reel body which is excessively wide. Furthermore, the mechanism is a significant departure from convention fishing reels and does not utilize existing designs for the unchanged functions.

Modem fishing reel manufacturers have employed friction-reducing mechanisms to increase the velocity of the terminal tackle, for the purpose of increasing casting distance during the fishine play-out operation. On the same fishing reel, various forms, i.e. mechanical and magnetic, of brakes have been employed to limit the rotational speed of the spool, for the purpose of reducing the backlash phenomena. Clearly, these two technologies operate in opposition to one another.

The invention as described improves upon existing artwork by eliminating friction between the fishline and the fishline guide during the play-out operation and allowing the spool to rotate at a much higher speed, while reducing the occurrence of backlash. This will contribute to greater casting distances, contributing to a more enjoyable fishing experience.

The invention as described is adaptable to virtually any double-bearing type fishing reel currently in production.

### SUMMARY OF THE INVENTION

In view of the above circumstances, it is an object of the invention to provide a fishline guide device which not only can reduce the resistance of a fishline when the fishline is played out, but also can carry out a fishline take-up operation smoothly and quickly.

To solve the above objects, there is a double bearing type reel including: a reel main body having a pair of side plates; a spool rotatably supported between the side plates; and a fishline guide device reciprocatingly provided between the side plates extending in front of the spool, the fishline guide device winding a fishline parallel around the spool.

The fishline guide device includes a two-piece fishline guide portion guiding the fishline right and left in a fishline take-up state, and a mechanism whereby the two pieces of the fishline guide portion separate into two halves, which will travel horizontally to positions adjacent to the side plates, eliminating any contact with the fishline in the play-out state. When the take-up operation is resumed, the two halves will rejoin to smoothly and quickly resume the function of the fishing reel.

### BRIEF DESCRIPTION OF THE DRAWINGS

FIG. 1. Is an exploded view of the components of the embodiment of the invention, as well as a sectional view of the components in an assembled state.

FIG 2. Is a rear view of the external components of the embodiment of the invention. The upper drawing is intended as the image in the fishline take-up state, and the lower drawing the fishline play-out state.

FIG 3. Is a front view of a double bearing type reel to which the embodiment of a fishline guide device according to the invention is applied to a reel using a fishline guide wire material. The upper drawing is intended as the image in the fishline take-up state, and the lower drawing the fishline play-out state.

FIG. 4. Is a similar to FIG. 3. in that it is a front view of a double bearing type reel to which the embodiment of a fishline guide device according to the invention is applied, in this case the fishline guide is constructed of a synthetic material, such as plastic, common on many contemporary reels of this type. The upper drawing is intended as the image in the fishline take-up state, and the lower drawing the fishline play-out state.

### DETAILED DESCRIPTION OF DRAWINGS

Now, description will be given below in detail of the present invention by means of the embodiments, components, and their functions thereof respectively shown in the accompanying drawings.

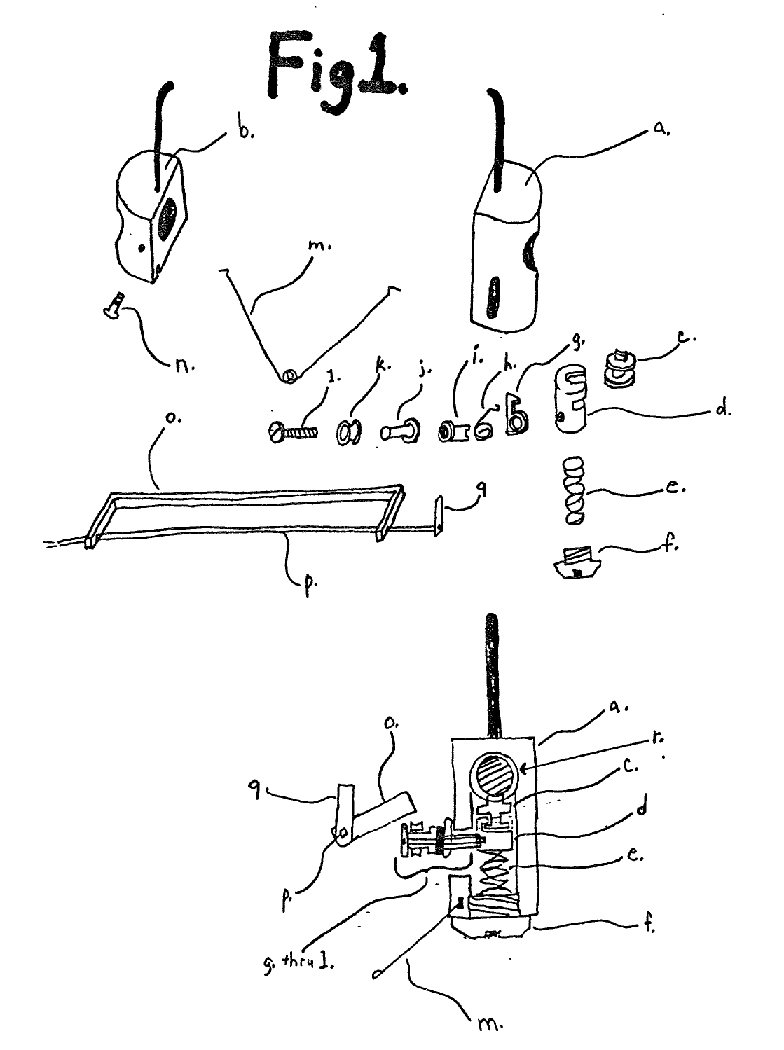

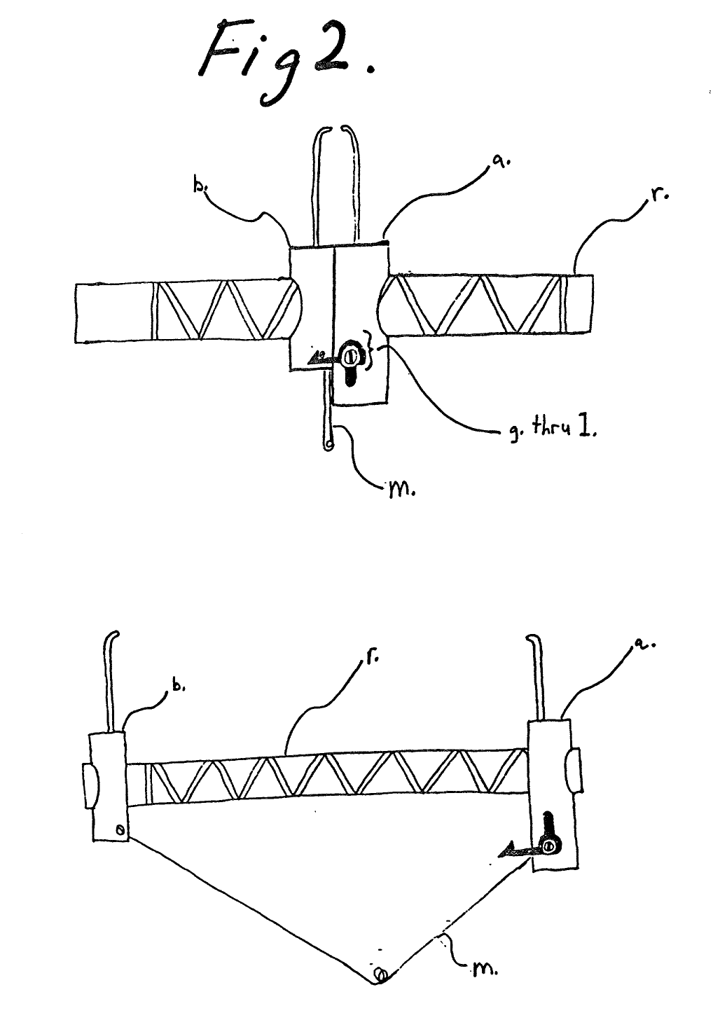

In FIG. 1., the following components are shown in exploded view:

a. Left Guide Housing

b. Right Guide Housing

c. Pawl

d. Pawl receiver

e. Retaining spring

f. Cap Screw

g. Guide Connecting Latch

h. Latch Spring

i. Latch Bushing

j. Roller Bushing

k. Roller

l. Roller Bolt

m. Separator Spring

n. Latch Pin

o. Rail

p. Rail Rod

q. Rail Lever

The lower sectional drawing on FIG. 1. depicts the above components in an assembled state, and introduces component r. Worm Gear, which will be more fully described in following drawings. As depicted, the drawing shows a side sectional view of the left guide housing, which has a large lateral hole accommodating the worm gear. Immediately beneath the worm gear is the pawl, pawl receiver, retaining spring and cap screw. Attached to the pawl receiver by means of an elongated opening on the rear of the left guide housing is the latch, latch spring, latch bushing, roller bushing and roller, all of which are held in place by the roller bolt, affixed to the pawl receiver by means of a threaded hole. Also depicted are the separator spring, attached to the adjacent surfaces of the left and right guide housings, of which the right guide housing is not evident in this drawing. Also shown is the rail, rail rod and rail lever.

In the upper and lower drawings of FIG. 2., the components are depicted in the fishline take-up and play-out states, respectively. In these drawings, the rail assembly has been omitted for clarity.

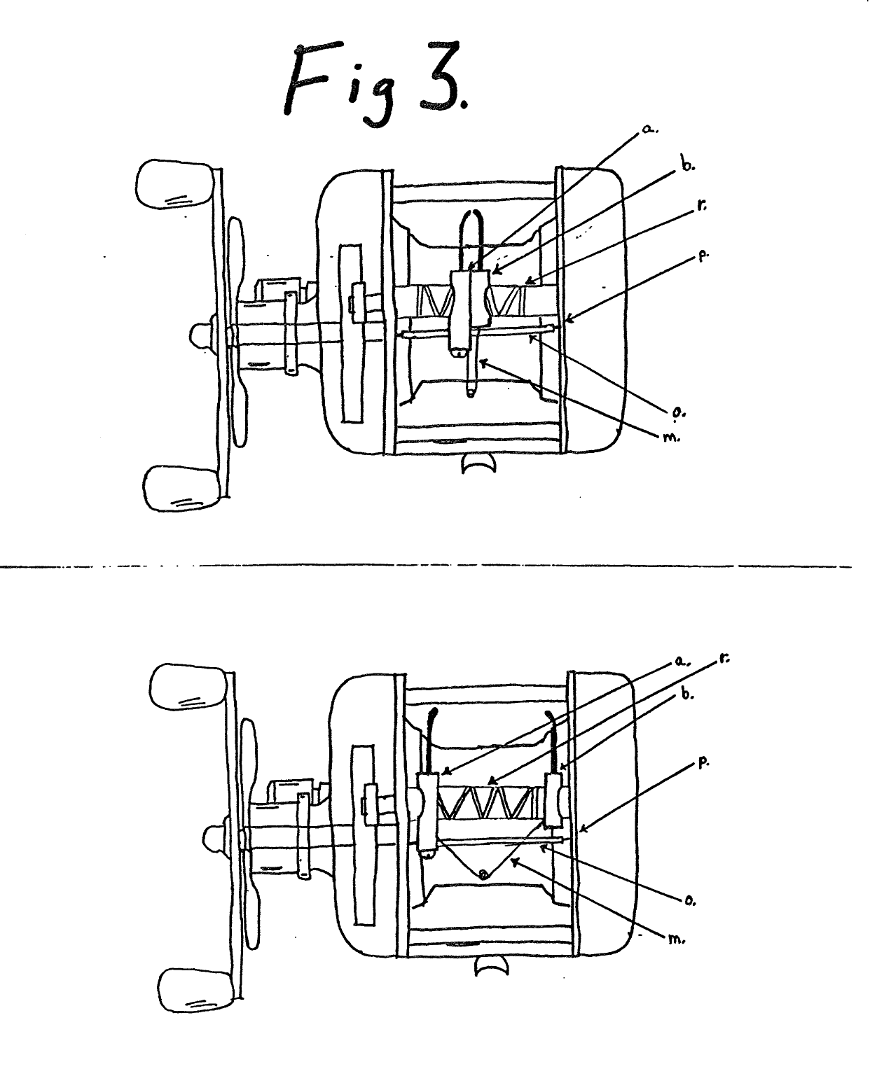

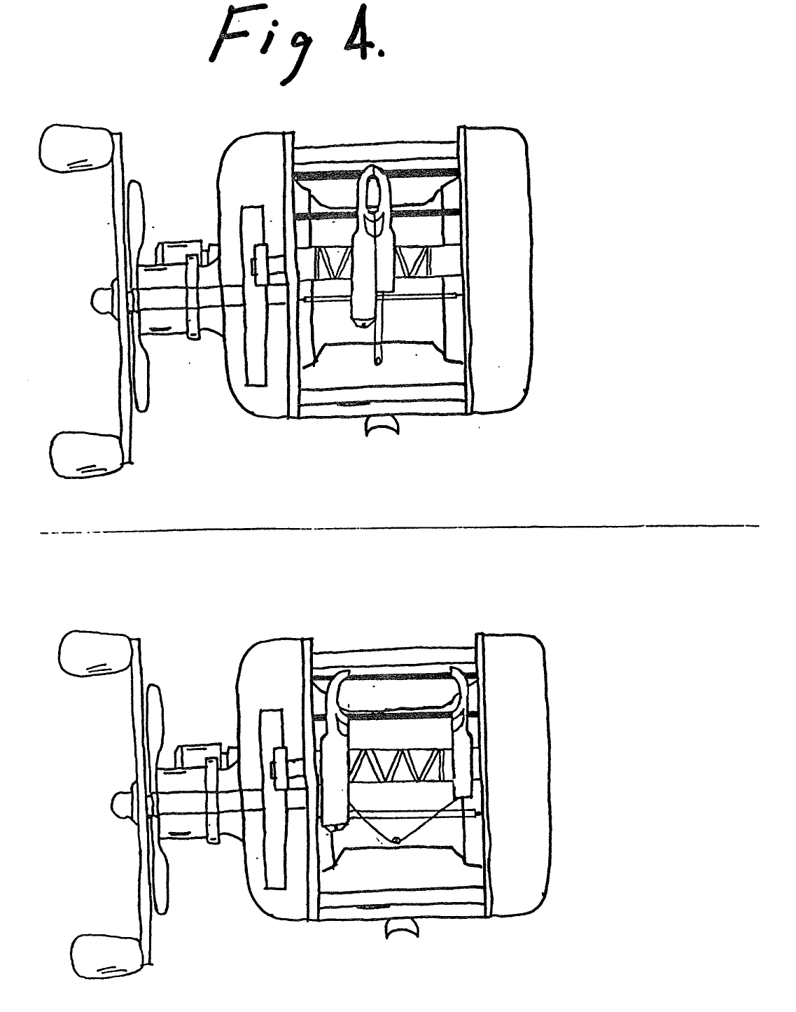

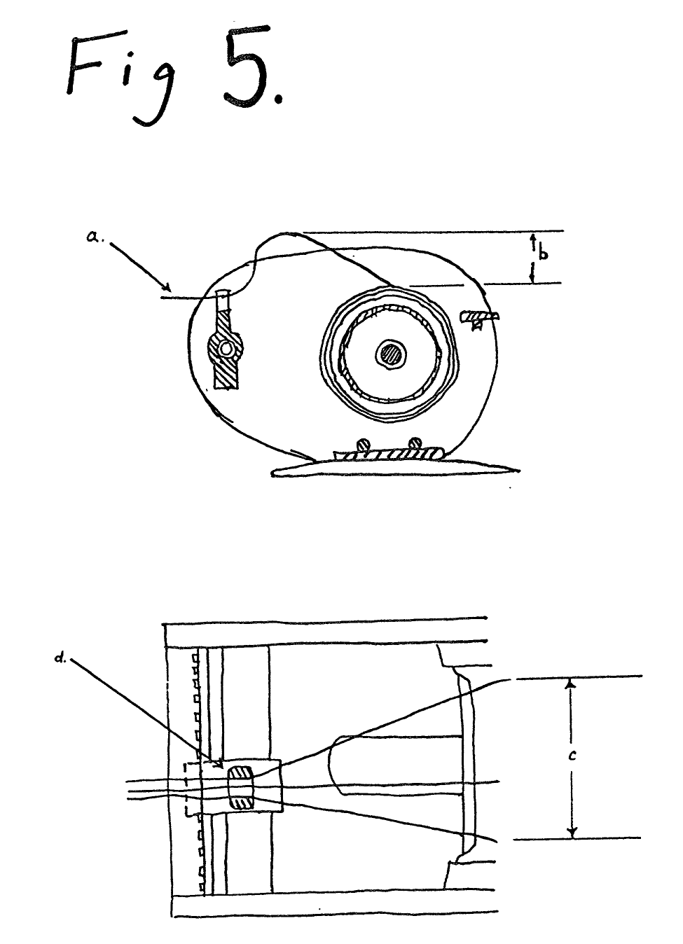

In FIG. 3., the components are depicted as they would appear on a double bearing type reel, both in the fishline take-up (upper drawing) and play-out (lower drawing) states.

In the operation of a double bearing type reel, the play out state is initiated by depressing some type of button on the rear of the reel. This button disengages the take-up mechanism, allowing the spool to turn freely. Once the fishline play-out has been completed, the take-up process is initiated by turning the crank handle, which re-engages the functions of rotating the spool for line retrieval while simultaneously turning the worm gear which provides for a reciprocating movement of the line guide, effectively distributing the line in an evenly overlapping manner across the width of the spool.

In the lower drawing on FIG. 1., when the fishline play-out is initiated, the rail lever will be rotated about the rail rod in a clockwise manner. This in turn will cause the rail to contact the roller causing the entire latch and pawl assembly to move in a downward manner, compressing the pawl retaining spring and removing the pawl from contact with the worm gear. As shown in FIG. 2., when the latch and pawl assemblies move in a downward manner, the latch no longer connects the two assemblies and with the force imparted by the separator spring, the right guide housing is free to slide until it contacts the reel side plate. Also, with no contact between the pawl and worm gear, the force imparted by the separator spring will cause the left guide housing to freely slide along the worm gear until contacting the opposite side plate. In these positions, the left and right guide housings in no way impede the free play-out of the fishline.

When the fishline play-out process has been completed, the turning of the crank handle will re-engage the fishline take-up process, the play-out button will return to its original position, turning the rail lever in a counter-clockwise manner. This will move the rail in an upward manner, allowing the latch and pawl assemble to move in a likewise upward manner, returning the pawl to its original contact position with the worm gear. When the pawl re-engages with the channels in the worm gear, the reciprocating motion of the left guide housing will move it across the worm gear until the latch re-engages the latch pin and fixes the left and right guide housings together, allowing both components to act as a single guide, moving in a reciprocating manner to distribute the fishline across the spool in an overlapping fashion.

The components function in the following manner: The pawl resides in the upper portion of the pawl receiver by means of a “U” shaped slot, allowing the pawl receiver to remain relatively fixed in the fishline take-up process, while the pawl partially rotates as needed relative to the contact with the worm gear. The pawl and pawl receiver are internal to the left guide housing, with pressure applied to the worm gear by means of the retaining spring, and the assembly is held in place with the cap screw.

The latch assembly is attached to the pawl receiver by access through an elongated hole on the rear of the left guide housing, the roller bolt securing the following components by means of a threaded hole in the pawl receiver: guide connecting latch, latch spring, latch bushing, roller bushing and roller. The latch bushing and roller bushing are components which will allow the roller bolt to be tightly affixed to the pawl receiver while allowing the necessary movement of the latch and roller. The latch bushing contacts the pawl receiver with two flanges, on the upper and lower contacting surface, set into two identical indentations on the pawl receiver. These features will prevent the latch bushing from turning and thus will retain tension on the latch spring. The latch bushing holds both the latch spring and latch in place, the latch spring retaining tension with one end in a slot on the cap of the latch bushing, and the other hooked under the latch. The latch springs function is to apply pressure to the latch, re-engaging and holding the latch in contact with the latch pin when initiating and completing the fishline take-up operation.

The roller bushing allows for free rotation of the roller, and the collar on the roller bushing retains the latch spring within the slot on the latch bushing. The roller rotates when in contact with the rail as the left and right guide housing separate during the initial fishline play-out procedure.

The latch pin engages with the latch to fix the left and right guide housings together during the fishline take-up operation.

The separator spring provides the force to separate the left and right guide housings during the fishline play-out operation.

The rail assembly provides for the disengagement of the pawl and a path of travel for the roller to initiate the fishline play-out operation.

What is claimed is:

1. A double bearing type reel comprising:
a reel main body having a pair of side plates;
a spool rotatably supported between the side plates; and
a fishline guide device reciprocatingly provided between the side plates extending in front of the spool, said fishline guide device winding a fishline parallel around the spool;
wherein the fishline guide device includes a fishline guide portion defined by a feature whereby the device is constructed to divide into two parts, effectively splitting with each half traveling to the adjacent edge of the side plate during the fishline play-out operation for the purpose minimizing friction between the fishline and the fishline guide device, while allowing the fishline to freely unwrap from the spool; and
wherein the fishline guide device returns to its original state upon the commencement of the fishline take-up operation to facilitate the winding of the fishline around the spool.
